(19) United States
(12) Patent Application Publication
(10) Pub. No.: US 2025/0114794 A1
(43) Pub. Date: Apr. 10, 2025

(54) LIQUID FEEDING APPARATUS AND DROPLET GENERATING APPARATUS

(71) Applicant: CANON MEDICAL SYSTEMS CORPORATION, Tochigi (JP)

(72) Inventors: Kohei SARUWATARI, Kawasaki (JP); Yusuke OWAKI, Moka (JP); Kenta KAMINO, Utsunomiya (JP); Yoshihiro KATO, Ohta-ku (JP)

(73) Assignees: CANON MEDICAL SYSTEMS CORPORATION, Tochigi (JP); Canon Kabushiki Kaisha, Tokyo (JP)

(21) Appl. No.: 18/906,777

(22) Filed: Oct. 4, 2024

(30) Foreign Application Priority Data
Oct. 6, 2023 (JP) 2023-174549

(51) Int. Cl. B01L 3/00

(52) U.S. Cl. CPC B01L 3/502784; B01L 2400/049

(57) ABSTRACT

A liquid feeding apparatus according to an embodiment includes a collection vessel holder, a liquid feeding tube, and processing circuitry. The collection vessel holder is configured to hold a collection vessel used for collecting liquid including a droplet layer and a non-droplet layer. The liquid feeding tube is configured to feed the liquid from the inside of the collection vessel. The processing circuitry is configured to adjust the position of an interface between the droplet layer and the non-droplet layer with respect to the position of a suction port of the liquid feeding tube.

### CROSS-REFERENCE TO RELATED APPLICATIONS

This application is based upon and claims the benefit of priority from Japanese Patent Application No. 2023-174549, filed on Oct. 6, 2023; the entire contents of which are incorporated herein by reference.

### FIELD

Embodiments described herein relate generally to a liquid feeding apparatus and a droplet generating apparatus.

### BACKGROUND

Conventionally, a method is known by which droplets enclosing cells or the like are generated by using a micro flow path. According to this method, for example, oil is caused to flow in a flow path connected so as to oppose another flow path in which sample liquid including the cells is flowing, so that the droplets are generated as a result of the oil shearing the sample liquid. The generated droplets are collected, together with the oil, into a collection vessel, so as to be subsequently used in various types of analyses.

In this situation, when the droplets collected in the collection vessel are to be used in the analyses, the droplets are sucked from the collection vessel and feeded. In a normal feeding of the droplets, the droplets are sucked together with the oil, and the feeding is performed at a low flow rate to prevent the droplets from being broken. However, when the feeding is performed at a low flow rate, because the feeding takes a long time, some of the cells in the droplets may die, or the droplets may be fused together (called demulsification) in some situations. To cope with these circumstances, there is a demand for the capability to selectively suck and feed the droplets from the inside of the collection vessel, for the purpose of shortening the time period required by the feeding of the droplets.

In relation to the above, as a technique for automatically feeding a specific solution in a container, a method is known by which, for example, an interface of the solution in the container is detected while using an optical method or an electrical method, so as to suck the solution by moving a suction tube configured to suck the solution, on the basis of position information of the detected interface.

### BRIEF DESCRIPTION OF THE DRAWINGS

FIG. 1 is a block diagram illustrating an exemplary configuration of a liquid feeding apparatus according to a first embodiment;

FIG. 2 is a schematic drawing illustrating an outline of a process performed by the liquid feeding apparatus according to the first embodiment;

FIG. 3 is a drawing for explaining collection of droplets using a collection vessel according to the first embodiment;

FIG. 4 is a drawing for explaining an example of the process performed by the liquid feeding apparatus according to the first embodiment;

FIG. 5 is a flowchart illustrating a procedure in the process performed by the liquid feeding apparatus according to the first embodiment;

FIG. 6 is a block diagram illustrating an exemplary configuration of a liquid feeding apparatus according to a second embodiment;

FIG. 7 is a flowchart illustrating a procedure in a process performed by the liquid feeding apparatus according to the second embodiment;

FIG. 8 is a drawing for explaining an example of a process performed by a liquid feeding apparatus according to a third embodiment;

FIG. 9 is a flowchart illustrating a procedure in the process performed by the liquid feeding apparatus according to the third embodiment;

FIG. 10 is a flowchart illustrating a procedure in a process performed by a liquid feeding apparatus according to a fourth embodiment;

FIG. 11 is a block diagram illustrating an exemplary configuration of a liquid feeding apparatus according to a fifth embodiment;

FIG. 12 is a flowchart illustrating a procedure in a process performed by the liquid feeding apparatus according to the fifth embodiment;

FIG. 13 is a block diagram illustrating an exemplary configuration of a droplet generating apparatus according to a sixth embodiment; and

FIG. 14 is a flowchart illustrating a procedure in a process performed by the droplet generating apparatus according to the sixth embodiment.

### DETAILED DESCRIPTION

A liquid feeding apparatus according to an embodiment includes a collection vessel holder, a liquid feeding tube, and processing circuitry. The collection vessel holder is configured to hold a collection vessel used for collecting liquid including a droplet layer and a non-droplet layer. The liquid feeding tube is configured to feed the liquid from the inside of the collection vessel. The processing circuitry is configured to adjust the position of an interface between the droplet layer and the non-droplet layer with respect to the position of a suction port of the liquid feeding tube.

Exemplary embodiments of a liquid feeding apparatus and a droplet generating apparatus of the present disclosure will be explained in detail below, with reference to the accompanying drawings. Further, possible embodiments of the liquid feeding apparatus and the droplet generating apparatus of the present disclosure are not limited to the following embodiments. Also, in the following description, some of the constituent elements that are the same as each other will be referred to by using the same reference characters, and duplicate explanations thereof will be omitted.

### First Embodiment

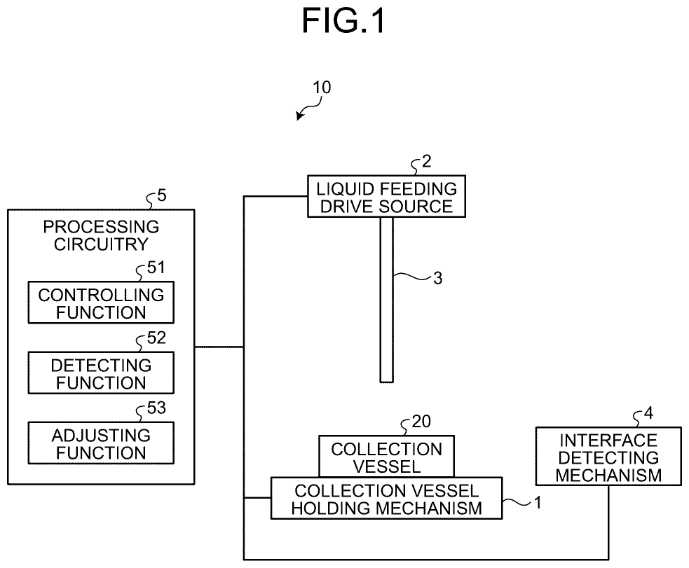

FIG. 1 is a block diagram illustrating an exemplary configuration of a liquid feeding apparatus 10 according to a first embodiment. As illustrated in FIG. 1, the liquid feeding apparatus 10 according to the present embodiment includes a collection vessel holding mechanism 1, a liquid feeding drive source 2, a liquid feeding tube 3, an interface detecting mechanism 4, and processing circuitry 5 and is configured to feed droplets from a collection vessel 20 held by the collection vessel holding mechanism 1 to a liquid feeding destination (not illustrated).

The collection vessel holding mechanism 1 is configured to hold the collection vessel 20 used for collecting liquid including a droplet layer and a non-droplet layer. More specifically, the collection vessel holding mechanism 1 is configured to hold the collection vessel 20 to collect the liquid including droplets formed by a micro flow path and a continuous phase fluid (e.g., oil) used for generating the droplets. In this situation, the collection vessel holding mechanism 1 is configured to be able to adjust the position of the collection vessel 20 with respect to the liquid feeding tube 3, and this configuration will be explained in detail later. In this situation, the collection vessel holding mechanism 1 is an example of a collection vessel holder.

The liquid feeding drive source 2 is a drive source for feeding the droplets in the collection vessel 20 to the liquid feeding destination and is realized by using a syringe pump, a pressure pump, or the like. For example, the liquid feeding drive source 2 has the liquid feeding tube 3 connected thereto and is configured to suck the droplets from the inside of the collection vessel 20 via the liquid feeding tube 3. Further, for example, the liquid feeding drive source 2 is configured to feed the sucked droplets to the liquid feeding destination, via a tube different from the liquid feeding tube 3.

The liquid feeding tube 3 is a tube used for feeding the liquid from the inside of the collection vessel 20 and is realized by using a fluoride resin tube such as a polytetrafluoroethylene (PTFE) tube. In this situation, as the liquid feeding tube 3, it is acceptable to use any tube, as long as the tube has chemical resistance and has little impact on the droplets and a sample included in the droplets. For example, the liquid feeding tube 3 may be configured so that one end part thereof is connected the liquid feeding drive source 2, whereas the other end part thereof serves as a suction port for sucking the droplets. The liquid feeding tube 3 is configured to feed the droplets from the inside of the collection vessel 20, by transmitting suction force generated by the liquid feeding drive source 2 to the droplets in the collection vessel 20. In this situation, the liquid feeding tube 3 is an example of a liquid feeding tube.

The interface detecting mechanism 4 is configured to obtain information for detecting interfaces included in the collection vessel 20. More specifically, the interface detecting mechanism 4 is configured to obtain information for detecting an interface between the droplet layer and the non-droplet layer in the collection vessel 20. Further, the interface detecting mechanism 4 is configured to obtain information for detecting an interface between the suction port of the liquid feeding tube 3 and the liquid, in the collection vessel 20. For example, the interface detecting mechanism 4 is realized by using a camera or a photoelectric sensor and a memory configured to transmit the obtained information to the processing circuitry 5, or the like. As the interface detecting mechanism 4, it is acceptable to use any mechanism, as long as the mechanism is capable of detecting the interfaces while having little impact on the droplets and the sample included in the droplets.

The processing circuitry 5 is configured to control various types of processes performed in the liquid feeding apparatus 10. For example, the processing circuitry 5 is realized by using one or more processors. In this situation, the processing circuitry 5 is configured to control the various types of processes performed in the liquid feeding apparatus 10, for example, in accordance with various types of operations received via an input interface (not illustrated).

The processing circuitry 5 is configured to execute a controlling function 51, a detecting function 52, and an adjusting function 53, by reading and executing programs stored in storage circuitry (not illustrated). The processing circuitry 5 is an example of processing circuitry.

The controlling function 51 is configured to control processes related to the feeding of the droplets, by controlling the liquid feeding drive source 2. For example, the controlling function 51 is configured to control a flow rate at the time of feeding the droplets and the like.

The detecting function 52 is configured to detect the position of the interface between the droplet layer and the non-droplet layer in the collection vessel 20. More specifically, the detecting function 52 is configured to detect the position of the interface between the droplet layer and the non-droplet layer in the collection vessel 20, on the basis of the information obtained by the interface detecting mechanism 4. Further, the detecting function 52 is also capable of detecting the interface between the suction port of the liquid feeding tube 3 and the liquid, within the collection vessel 20, on the basis of the information obtained by the interface detecting mechanism 4. Processes performed by the detecting function 52 will be explained in detail later.

The adjusting function 53 is configured to adjust the position of the interface between the droplet layer and the non-droplet layer, with respect to the position of the suction port of the liquid feeding tube. More specifically, the adjusting function 53 is configured to adjust the position of the interface between the droplet layer and the non-droplet layer with respect to the position of the suction port of the liquid feeding tube, on the basis of the position of the interface between the droplet layer and the non-droplet layer detected by the detecting function 52. Processes performed by the adjusting function 53 will be explained in detail later.

A configuration of the liquid feeding apparatus 10 has thus been explained. The liquid feeding apparatus 10 structured as described above is configured to make it possible to properly feed the droplets. As explained above, there is a demand for the capability to selectively suck and feed the droplets in the collection vessel, for the purpose of shortening the time period required by the feeding of the droplets. However, when an attempt is made to selectively suck the droplets by moving the liquid feeding tube used for sucking the droplets, there is a possibility that the droplets may not properly be feeded due to difficulty in controlling the liquid feeding tube. More specifically, because the liquid feeding tube for feeding the droplets is made of a soft material, meandering may occur at the time of moving the tube, and the feeding may not properly be performed. In addition, the length of the liquid feeding tube is determined in advance, and also, the liquid feeding tube may be fixed in some situations. Thus, the feeding may not properly be performed due to incapability to freely move the liquid feeding tube.

To cope with the circumstances described above, the liquid feeding apparatus 10 according to the present embodiment is configured to selectively collect and feed the droplets from the inside of the collection vessel, without the need to control the liquid feeding tube. More specifically, the liquid feeding apparatus 10 is configured to selectively collect and feed the droplets from the inside of the collection vessel 20, by detecting the interface between the droplet layer and the non-droplet layer in the collection vessel 20 and controlling the position of the interface.

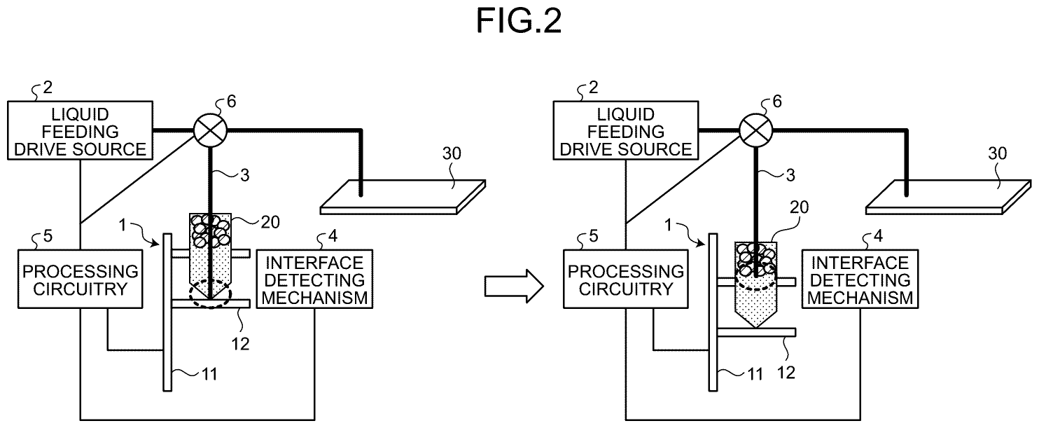

FIG. 2 is a schematic drawing illustrating an outline of a process performed by the liquid feeding apparatus 10 according to the first embodiment. FIG. 2 illustrates an example in which the droplets in the collection vessel 20 are feeded to a micro flow path 30 used for detection/analysis purposes. As illustrated in FIG. 2, the collection vessel holding mechanism 1 of the liquid feeding apparatus 10 includes a supporting unit 11 and an arm 12, while the arm 12 is configured to hold the collection vessel 20.

The supporting unit 11 is configured to support the arm 12 so as to be movable along vertical directions. The arm 12 is supported by the supporting unit 11 so as to be movable along the vertical directions and is configured to hold the collection vessel 20. Further, by the adjusting function 53 of the processing circuitry 5, the arm 12 is moved in up-and-down directions along the vertical directions.

Under control of the processing circuitry 5, as illustrated in FIG. 2, the liquid feeding apparatus 10 according to the first embodiment is configured to selectively feed the droplets in the collection vessel 20, by detecting the interface between the droplet layer and the non-droplet layer of the liquid in the collection vessel 20 and adjusting the position of the arm 12 so that the position of the detected interface is aligned with the position of the suction port of the liquid feeding tube 3.

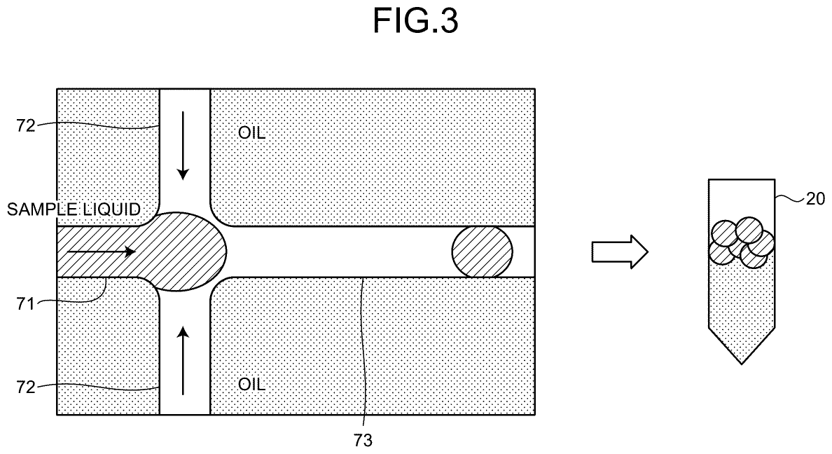

Next, a state inside the collection vessel 20 will be explained, with reference to FIG. 3. FIG. 3 is a drawing for explaining the collection of the droplets using the collection vessel 20 according to the first embodiment. FIG. 3 illustrates a part of the micro flow path used for generating the droplets, as well as the collection vessel 20 in a state of having collected the droplets generated by the micro flow path.

As illustrated in FIG. 3, the micro flow path used for generating the droplets includes: a flow path 71 connected to an injection port used for injecting sample liquid (e.g., a solution containing the cells) to be enclosed in the droplets; a flow path 72 connected to an injection port used for injecting the oil for generating the droplets; and a flow path 73 through which the generated droplets flow.

To the injection port connected to the flow path 71, a supply unit (e.g., a syringe pump or a pressure pump) configured to supply the sample liquid is connected. Further, to the injection port connected to the flow path 72, a supply unit (e.g., a syringe pump or a pressure pump) configured to supply the oil is connected. The supply units are configured to pump out the sample liquid and the oil at flow rates set in advance. As a result, the sample liquid and the oil are caused to flow in the directions indicated by the arrows in FIG. 3, so that the oil shears the sample liquid, and the droplets enclosing the sample liquid are generated.

In association with the supplies of the oil and the sample liquid from the supply units, the droplets generated in a region where the flow path 71 intersects the flow path 72 flow through the flow path 73 together with the oil and are collected into the collection vessel 20. The droplets and the oil collected by the collection vessel 20 are separated into the droplet layer being a top layer and an oil layer (the non-droplet layer) being a bottom layer, as illustrated in FIG. 3.

The liquid feeding apparatus 10 is configured to detect a boundary (the interface) between the droplet layer and the oil layer in the collection vessel 20 and, as illustrated in the right section of FIG. 2, to move the arm 12 so that the position of the detected interface is aligned with the position of the suction port of the liquid feeding tube 3, before subsequently starting to have the liquid in the collection vessel 20 sucked by controlling the liquid feeding drive source 2. In this situation, because the position of the detected interface is aligned with the position of the suction port of the liquid feeding tube 3, it is possible to suck the droplets without sucking extra oil (the oil in the oil layer). In this situation, when the droplets are sucked from the collection vessel 20, the processing circuitry 5 is configured to control a switching valve 6 so that the suction force generated by the liquid feeding drive source 2 is transmitted to the suction port of the liquid feeding tube 3. Further, when the droplets have been sucked from the collection vessel 20, the processing circuitry 5 is configured to control the switching valve 6 so that an exit port of the liquid feeding tube for pumping the droplets into the micro flow path 30 is connected to the liquid feeding drive source 2. After that, the processing circuitry 5 is configured to pump out the droplets at a flow rate corresponding to the micro flow path 30.

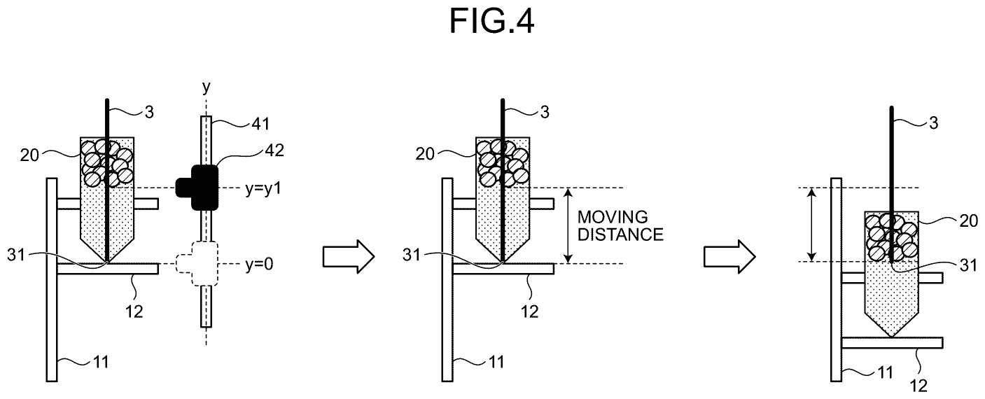

As explained above, the liquid feeding apparatus 10 is configured to move the position of the interface so that the position of the interface is aligned with the position of the suction port of the liquid feeding tube 3. Next, details of a process performed by the liquid feeding apparatus 10 will be explained with reference to FIG. 4. FIG. 4 is a drawing for explaining an example of the process performed by the liquid feeding apparatus 10 according to the first embodiment. FIG. 4 illustrates the example in which a camera is used as the interface detecting mechanism 4. Also, FIG. 4 illustrates the example in which, when the liquid feeding tube 3 is arranged with the collection vessel 20, a suction port 31 of the liquid feeding tube 3 is in contact with the bottom of the collection vessel 20. In other words, in the present example, an initial arrangement state of the liquid feeding tube 3 with respect to the collection vessel 20 corresponds to the state in which the suction port 31 is in contact with the bottom of the collection vessel 20.

As illustrated in the left section of FIG. 4, when the liquid feeding tube 3 is arranged with the collection vessel 20, the detecting function 52 is configured to detect the interface between the droplet layer and the oil layer in the collection vessel 20, by controlling the interface detecting mechanism 4. More specifically, by controlling the interface detecting mechanism 4 structured with a camera 42 and a supporting unit 41 supporting the camera 42, the detecting function 52 is configured to obtain an image capturing the inside of the collection vessel 20 and to detect the interface between the droplet layer and the oil layer in the collection vessel 20 on the basis of the obtained image. In this situation, the supporting unit 41 is configured to support the camera 42 so as to be movable along the vertical directions. In other words, the camera 42 is configured to be able to move along the lengthwise direction of the liquid feeding tube 3.

For example, as illustrated in the left section of FIG. 4, the detecting function 52 is configured to acquire the image of the inside of the collection vessel 20 while moving the camera 42 along the supporting unit 41 and to detect the interface between the droplet layer and the oil layer from within the acquired image. In one example, the detecting function 52 is configured to detect a position in which a difference in pixel values between adjacently-positioned pixels exceeds a threshold value within the image capturing the inside of the collection vessel 20, as the interface between the droplet layer and the oil layer. In this situation, possible methods for detecting the interface using an image are not limited to the above example. It is also acceptable to use other known methods.

After that, the detecting function 52 is configured to specify an image rendering the interface in the same position as the position of the bottom of the collection vessel 20 rendered in an image captured by the camera positioned at the height “y=0” in the drawing and to further obtain the height “y=y1” of the camera corresponding to the time when the specified image was captured. Further, as illustrated in the middle section of FIG. 4, the detecting function 52 is configured to calculate a moving distance of the camera from the height “y=0” to the height “y=y1”. In other words, the detecting function 52 is configured to calculate the distance from the bottom of the collection vessel (the suction port 31 of the liquid feeding tube 3) to the interface.

The adjusting function 53 is configured to align the position of the suction port 31 of the liquid feeding tube 3 with the position of the interface, by adjusting the position in which the collection vessel 20 is held by the collection vessel holding mechanism 1, on the basis of the position of the interface between the droplet layer and the non-droplet layer. More specifically, the adjusting function 53 is configured align the position of the interface with the position of the suction port 31 of the liquid feeding tube 3, by moving the collection vessel holding mechanism 1 by the distance between the position of the interface and the position of the suction port of the liquid feeding tube. In other words, the adjusting function 53 is configured to align the position of the suction port 31 with the position of the interface, by moving the arm 12 on the basis of a result of the detection by the detecting function 52. For example, as illustrated in the right section of FIG. 4, the adjusting function 53 is configured to move the arm 12 downward, by the moving distance of the camera (the distance from the suction port 31 of the liquid feeding tube 3 to the interface) calculated by the detecting function 52. As a result, the height of the suction port 31 of the liquid feeding tube 3 has become equal to the height of the interface.

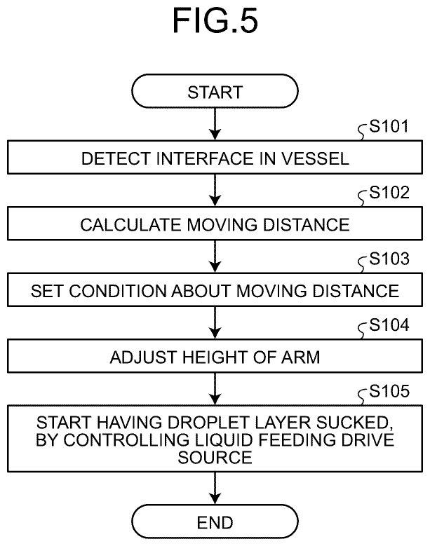

Next, a procedure in a process performed by the liquid feeding apparatus 10 will be explained, with reference to FIG. 5. FIG. 5 is a flowchart illustrating the procedure in the process performed by the liquid feeding apparatus 10 according to the first embodiment.

For example, as illustrated in FIG. 5, in the present embodiment, the detecting function 52 detects the interface in the collection vessel 20 (step S101) and calculates a moving distance of the camera (step S102). The abovementioned process is realized, for example, as a result of the processing circuitry 5 invoking and executing a program corresponding to the detecting function 52 from the storage circuitry (not illustrated).

Subsequently, on the basis of the calculated moving distance of the camera 42, the adjusting function 53 sets a condition about a moving distance of the arm 12 (step S103) and adjusts the height of the arm 12 (step S104). The abovementioned process is realized, for example, as a result of the processing circuitry 5 invoking and executing a program corresponding to the adjusting function 53 from the storage circuitry (not illustrated).

After that, the controlling function 51 starts having the droplet layer sucked, by controlling the liquid feeding drive source 2 (step S105). The abovementioned process is realized, for example, as a result of the processing circuitry 5 invoking and executing a program corresponding to the controlling function 51 from the storage circuitry (not illustrated).

As explained above, according to the first embodiment, the collection vessel holding mechanism 1 is configured to hold the collection vessel 20 used for collecting the liquid including the droplet layer and the non-droplet layer. The liquid feeding tube 3 is configured to feed the liquid from the inside of the collection vessel 20. The adjusting function 53 is configured to adjust the position of the interface between the droplet layer and the non-droplet layer, with respect to the position of the suction port 31 of the liquid feeding tube 3. Consequently, the liquid feeding apparatus 10 according to the first embodiment is able to align the position of the interface with the position of the suction port, without the need to move the liquid feeding tube 3, and is thus able to shorten the time period required by the feeding of the droplets. As a result, the liquid feeding apparatus 10 makes it possible to properly feed the droplets.

Further, according to the first embodiment, the detecting function 52 is configured to detect the position of the interface between the droplet layer and the non-droplet layer in the collection vessel 20. On the basis of the position of the interface between the droplet layer and the non-droplet layer detected by the detecting function 52, the adjusting function 53 is configured to adjust the position of the interface between the droplet layer and the non-droplet layer with respect to the position of the suction port 31 of the liquid feeding tube 3. Consequently, the liquid feeding apparatus 10 according to the first embodiment is able to align the position of the interface with the position of the suction port with a higher level of precision and thus makes it possible to feed the droplets more properly.

In addition, according to the first embodiment, the adjusting function 53 is configured to align the position of the suction port 31 of the liquid feeding tube 3 with the position of the interface, by adjusting the position in which the collection vessel 20 is held by the collection vessel holding mechanism 1, on the basis of the position of the interface between the droplet layer and the non-droplet layer. Consequently, the liquid feeding apparatus 10 according to the first embodiment makes it possible to easily move the interface between the droplet layer and the non-droplet layer.

Furthermore, according to the first embodiment, the adjusting function 53 is configured to align the position of the interface with the position of the suction port 31 of the liquid feeding tube 3, by moving the collection vessel holding mechanism 1 by the distance between the position of the interface and the position of the suction port 31 of the liquid feeding tube 3. Consequently, the liquid feeding apparatus 10 according to the first embodiment makes it possible to easily align the position of the suction port 31 of the liquid feeding tube 3 with the position of the interface.

### Second Embodiment

In the first embodiment above, the example was explained in which, after the detected position of the interface is aligned with the position of the suction port 31 of the liquid feeding tube 3, the suction of the droplets by the liquid feeding drive source 2 is started. As a second embodiment, an example will be explained in which a result of the position alignment is judged so as to perform a position alignment again in accordance with a result of the judgment.

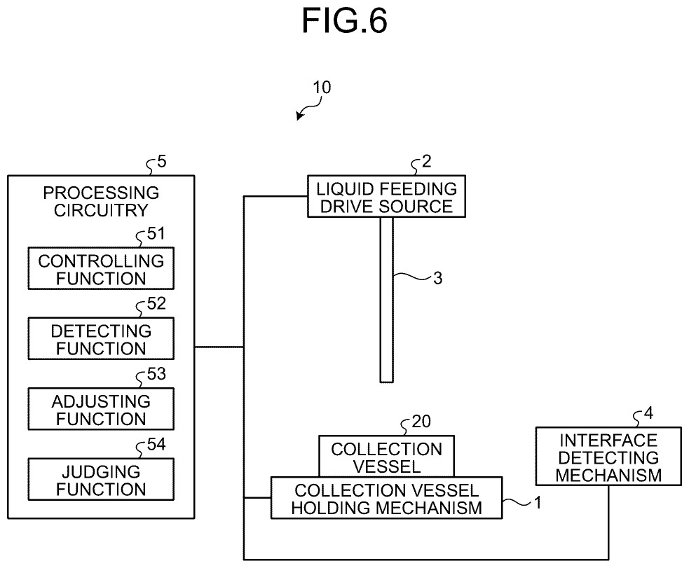

FIG. 6 is a block diagram illustrating an exemplary configuration of the liquid feeding apparatus 10 according to the second embodiment. In this situation, the liquid feeding apparatus 10 according to the second embodiment is different from the liquid feeding apparatus 10 according to the first embodiment in that the processing circuitry 5 executes a judging function 54 and that the detecting function 52 and the adjusting function 53 are configured to perform additional processes. In the following sections, these differences will primarily be explained.

After the position of the interface is adjusted with respect to the position of the suction port 31 of the liquid feeding tube 3, the judging function 54 is configured to judge a positional relationship between the position of the suction port 31 and the position of the interface. More specifically, the judging function 54 is configured to judge whether or not the position of the interface is aligned with the position of the suction port 31 of the liquid feeding tube 3. For example, after the position alignment process is performed by the adjusting function 53, the detecting function 52 is configured to obtain an image of the inside of the collection vessel 20 by controlling the interface detecting mechanism 4 and to detect the interface between the droplet layer and the oil layer and the suction port 31 of the liquid feeding tube 3 in the collection vessel 20 that were obtained. In this situation, the detecting function 52 is able to detect the suction port 31 of the liquid feeding tube 3 within the image, by performing existing image processing such as pattern matching.

The judging function 54 is configured to judge whether or not the position of the interface detected by the detecting function 52 is aligned with the position of the suction port 31. For example, the judging function 54 is configured to judge whether or not a difference between the position of the interface and the position of the suction port 31 is within a threshold value. In this situation, when the difference between the position of the interface and the position of the suction port 31 is within the threshold value, the judging function 54 is configured to determine that the position of the interface is aligned with the position of the suction port 31. On the contrary, when the difference between the position of the interface and the position of the suction port 31 exceeds the threshold value, the judging function 54 is configured to determine that the position of the interface is not aligned with the position of the suction port 31. In this situation, the abovementioned threshold value is arbitrarily set in advance.

On the basis of the judgment result of the positional relationship, the adjusting function 53 is configured to re-adjust the position of the interface with respect to the position of the suction port 31. More specifically, when the judging function 54 determines that the position of the interface is not aligned with the position of the suction port 31, the adjusting function 53 is configured to re-adjust the position of the interface with respect to the position of the suction port 31. For example, the adjusting function 53 is configured to adjust the height of the arm 12 so that the difference between the position of the interface and the position of the suction port 31 falls within the threshold value.

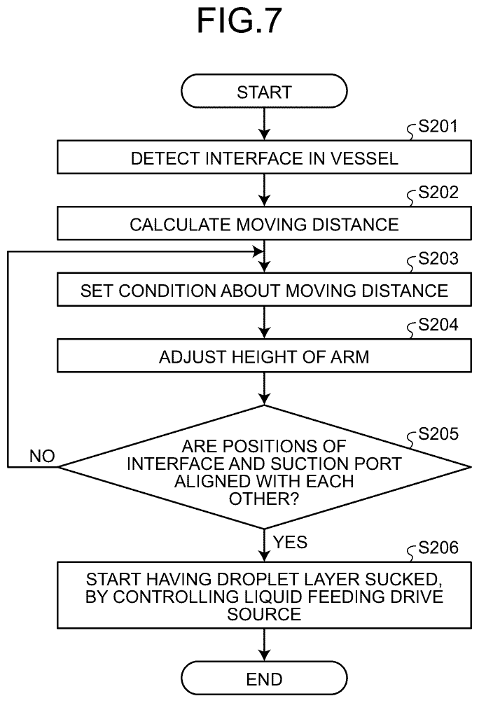

Next, a procedure in a process performed by the liquid feeding apparatus 10 according to the second embodiment will be explained, with reference to FIG. 7. FIG. 7 is a flowchart illustrating the procedure in the process performed by the liquid feeding apparatus 10 according to the second embodiment. In the present example, steps S201 through S204 and S206 in FIG. 7 are the same as the processes at steps S101 through S105 in FIG. 5.

For example, in the second embodiment, as illustrated in FIG. 7, the detecting function 52 detects the interface in the collection vessel 20 (step S201) and calculates a moving distance of the camera (step S202). Subsequently, on the basis of the calculated moving distance of the camera 42, the adjusting function 53 sets a condition about a moving distance of the arm 12 (step S203) and adjusts the height of the arm 12 (step S204).

After that, the judging function 54 judges whether or not the positions of the interface and the suction port 31 are aligned with each other (step S205). The abovementioned process is realized, for example, as a result of the processing circuitry 5 invoking and executing a program corresponding to the judging function 54 from the storage circuitry (not illustrated).

In this situation, when it is determined that the positions of the interface and the suction port 31 are not aligned with each other (step S205: No), the process returns to step S203 where the adjusting function 53 sets a condition about a moving distance of the arm 12 (step S203) and adjusts the height of the arm 12 (step S204).

On the contrary, when it is determined that the positions of the interface and the suction port 31 are aligned with each other (step S205: Yes), the controlling function 51 starts having the droplet layer sucked, by controlling the liquid feeding drive source 2 (step S206).

As explained above, according to the second embodiment, after the position of the interface is adjusted with respect to the position of the suction port 31 of the liquid feeding tube 3, the judging function 54 is configured to judge the positional relationship between the position of the suction port 31 and the position of the interface. On the basis of the result of the judgment on the positional relationship, the adjusting function 53 is configured to re-adjust the position of the interface with respect to the position of the suction port 31. Consequently, the liquid feeding apparatus 10 according to the second embodiment is able to selectively suck the droplets with a higher level of precision and thus makes it possible to feed the droplets more properly.

### Third Embodiment

In the first embodiment above, the example was explained in which the suction port 31 of the liquid feeding tube 3 is set in advance so as to be in contact with the bottom of the collection vessel 20. In a third embodiment, an example will be explained in which the suction port 31 of the liquid feeding tube 3 in the collection vessel 20 is detected. The liquid feeding apparatus 10 according to the third embodiment is different from the liquid feeding apparatus 10 according to the first embodiment for processes performed by the detecting function 52. In the following sections, the difference will primarily be explained.

The detecting function 52 according to the third embodiment is configured to further detect the suction port 31 of the liquid feeding tube 3 in the collection vessel 20. More specifically, the detecting function 52 is configured to detect the position of the suction port 31 of the liquid feeding tube 3 in the collection vessel 20, on the basis of information obtained by the interface detecting mechanism 4. For example, by performing existing image processing such as pattern matching on an image of the inside of the collection vessel 20 captured by the camera 42, the detecting function 52 is configured to detect the suction port 31 of the liquid feeding tube 3 rendered in the image.

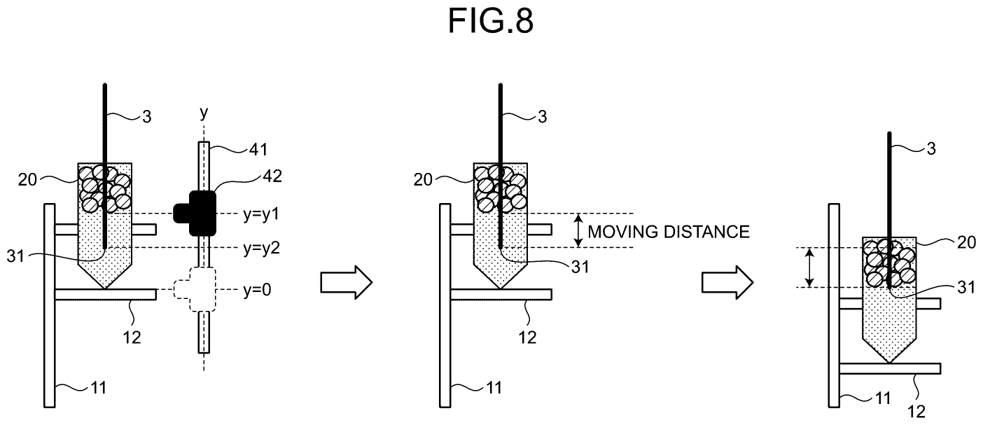

FIG. 8 is a drawing for explaining an example of a process performed by the liquid feeding apparatus 10 according to the third embodiment. FIG. 8 illustrates an example in which a camera is used as the interface detecting mechanism 4. As illustrated in the left section of FIG. 8, when the liquid feeding tube 3 is arranged with the collection vessel 20, the detecting function 52 is configured to detect the interface between the droplet layer and the oil layer and the suction port 31 of the liquid feeding tube 3 in the collection vessel 20, by controlling the interface detecting mechanism 4. More specifically, the detecting function 52 is configured to obtain an image capturing the inside of the collection vessel 20 by controlling the interface detecting mechanism 4 and to further detect the interface between the droplet layer and the oil layer and the suction port 31 of the liquid feeding tube 3 in the collection vessel 20, on the basis of the obtained image.

For example, as illustrated in the left section of FIG. 8, the detecting function 52 is configured to acquire the image of the inside of the collection vessel 20 while moving the camera 42 along the supporting unit 41 and to detect the interface between the droplet layer and the oil layer from within the acquired image. In an example, by performing the same process as in the first embodiment, the detecting function 52 is configured to detect the interface between the droplet layer and the oil layer from within the image and to calculate a moving distance of the camera from the height “y=0” to the height “y=y1”.

Further, the detecting function 52 is configured to detect the suction port 31 of the liquid feeding tube 3 from within the image acquired while moving the camera 42 along the supporting unit 41. After that, the detecting function 52 is configured to specify an image rendering the suction port 31 in the same position as the position of the bottom of the collection vessel 20 rendered in an image captured by the camera positioned at the height “y=0” in the drawing and to further obtain the height “y=y2” of the camera corresponding to the time when the specified image was captured. Further, as illustrated in the middle section of FIG. 8, the detecting function 52 is configured to calculate a moving distance “y1-y2” of the camera from the height “y=y2” to the height “y=y1”. In other words, the detecting function 52 is configured to calculate the distance from the suction port 31 of the liquid feeding tube 3 to the interface.

In this situation, an initial arrangement of the liquid feeding tube 3 with respect to the collection vessel 20 may arbitrarily be set in accordance with a liquid volume of the droplets to be generated. For example, as illustrated in the left section of FIG. 8, the suction port 31 of the liquid feeding tube 3 may be arranged at the oil layer (the non-droplet layer). Alternatively, the suction port 31 of the liquid feeding tube 3 may be arranged at the droplet layer.

On the basis of the position of the interface between the droplet layer and the non-droplet layer and the position of the suction port 31 of the liquid feeding tube 3 that were detected by the detecting function 52, the adjusting function 53 is configured to adjust the position of the interface between the droplet layer and the non-droplet layer, with respect to the position of the suction port 31 of the liquid feeding tube 3. More specifically, the adjusting function 53 is configured to align the position of the suction port 31 with the position of the interface, by moving the arm 12 on the basis of a result of the detection by the detecting function 52. For example, as illustrated in the right section of FIG. 8, the adjusting function 53 is configured to move the arm 12 downward by a moving distance “y1-y2” of the camera calculated by the detecting function 52. As a result, the height of the suction port 31 of the liquid feeding tube 3 has become equal to the height of the interface.

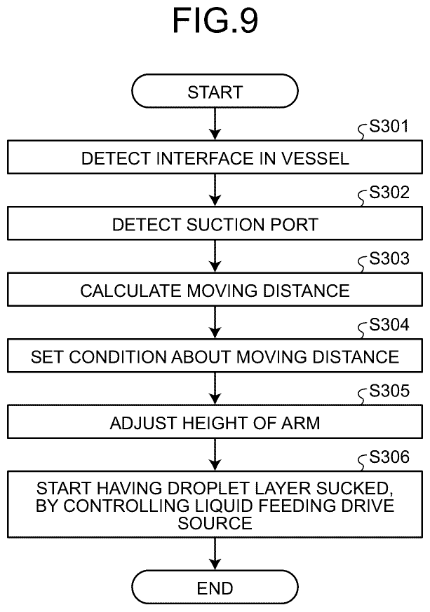

Next, a procedure in a process performed by the liquid feeding apparatus 10 according to the third embodiment will be explained, with reference to FIG. 9. FIG. 9 is a flowchart illustrating the procedure in the process performed by the liquid feeding apparatus 10 according to the third embodiment. In the present example, steps S301 and S304 through S306 in FIG. 9 are the same as the processes at steps S101 and S103 through S105 in FIG. 5.

For example, in the third embodiment, as illustrated in FIG. 9, the detecting function 52 detects the interface in the collection vessel 20 (step S301) and detects the suction port 31 of the liquid feeding tube 3 (step S302). Further, although FIG. 9 illustrates the example in which the suction port 31 is detected after the interface is detected, possible embodiments are not limited to this example. It is also acceptable to detect the interface after detecting the suction port 31.

After that, on the basis of the interface and the suction port 31 that were detected, the detecting function 52 calculates a moving distance of the camera 42 from the height of the camera 42 at which the interface was detected to the height of the camera 42 at which the suction port 31 was detected (step S303). The abovementioned process at steps S301 through S303 is realized, for example, as a result of the processing circuitry 5 invoking and executing the program corresponding to the detecting function 52 from the storage circuitry (not illustrated).

Subsequently, on the basis of the calculated moving distance of the camera 42, the adjusting function 53 sets a condition about a moving distance of the arm 12 (step S304) and adjusts the height of the arm 12 (step S305). After that, the controlling function 51 starts having the droplet layer sucked, by controlling the liquid feeding drive source 2 (step S306).

As explained above, according to the third embodiment, the detecting function 52 is configured to further detect the position of the suction port 31 of the liquid feeding tube 3 in the collection vessel 20. On the basis of the position of the interface between the droplet layer and the non-droplet layer and the position of the suction port 31 of the liquid feeding tube 3 that were detected by the detecting function 52, the adjusting function 53 is configured to adjust the position of the interface between the droplet layer and the non-droplet layer, with respect to the position of the suction port 31 of the liquid feeding tube 3. Consequently, the liquid feeding apparatus 10 according to the third embodiment is able to detect the position of the suction port 31 of the liquid feeding tube 3 and thus makes it possible to feed the droplets properly even when the position of the liquid feeding tube 3 is not determined in advance.

### Fourth Embodiment

In a fourth embodiment, an example will be explained in which the liquid feeding apparatus 10 according to the third embodiment is configured to judge a result of the position alignment, so that a position alignment is to be performed again in accordance with a result of the judgment. In other words, in the fourth embodiment, the liquid feeding apparatus 10 obtained by combining the second embodiment with the third embodiment will be explained.

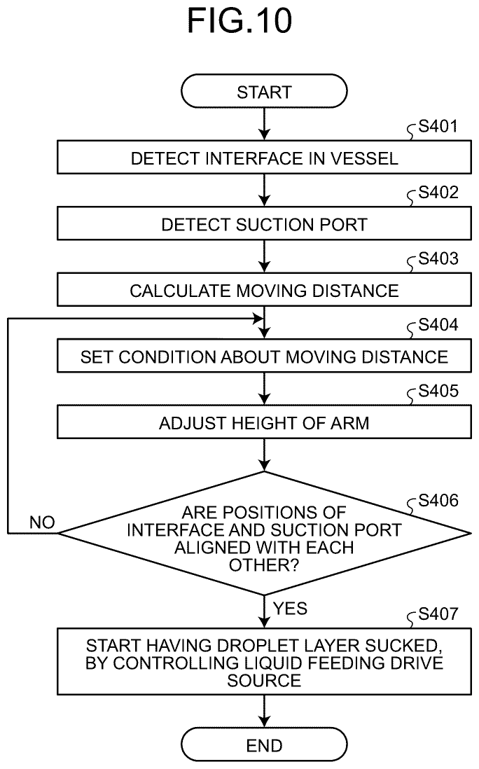

The liquid feeding apparatus 10 according to the fourth embodiment is configured to perform the processes described in the second embodiment and the processes described in the third embodiment. In the following sections, a procedure in a process performed by the liquid feeding apparatus 10 according to the fourth embodiment will be explained, with reference to FIG. 10. FIG. 10 is a flowchart illustrating the procedure in the process performed by the liquid feeding apparatus 10 according to the fourth embodiment. In the present example, steps S401 through S405 and S407 in FIG. 10 are the same as the processes at steps S301 through S306 in FIG. 9. Further, step S406 in FIG. 10 is the same as the process at step S205 in FIG. 7.

For example, in the fourth embodiment, as illustrated in FIG. 10, the detecting function 52 detects the interface in in the collection vessel 20 (step S401) and detects the suction port 31 of the liquid feeding tube 3 (step S402). Further, although FIG. 10 illustrates the example in which the suction port 31 is detected after the interface is detected, possible embodiments are not limited to this example. It is also acceptable to detect the interface after detecting the suction port 31. Further, the detecting function 52 calculates a moving distance of the camera 42 on the basis of the interface and the suction port 31 that were detected (step S403).

Subsequently, on the basis of the calculated moving distance of the camera 42, the adjusting function 53 sets a condition about a moving distance of the arm 12 (step S404) and adjusts the height of the arm 12 (step S405).

After that, the judging function 54 judges whether or not the positions of the interface and the suction port 31 are aligned with each other (step S406). In this situation, when it is determined that the positions of the interface and the suction port 31 are not aligned with each other (step S406: No), the process returns to step S404 where the adjusting function 53 sets a condition about a moving distance of the arm 12 (step S404) and adjusts the height of the arm 12 (step S405).

On the contrary, when it is determined that the positions of the interface and the suction port 31 are aligned with each other (step S406: Yes), the controlling function 51 starts having the droplet layer sucked, by controlling the liquid feeding drive source 2 (step S407).

As explained above, according to the fourth embodiment, the position of the suction port 31 of the liquid feeding tube 3 is detected, and also, the positional relationship between the interface and the suction port 31 after the position alignment is judged, so as to re-adjust the position of the interface with respect to the position of the suction port 31 in accordance with the result of the judgment. Consequently, the liquid feeding apparatus 10 according to the fourth embodiment is able to selectively suck the droplets with a higher level of precision even when the position of the liquid feeding tube 3 is not determined in advance and thus makes it possible to feed the droplets more properly.

### Fifth Embodiment

In the first embodiment above, the example was explained in which the position of the interface is detected by using the interface detecting mechanism 4. In a fifth embodiment, an example will be explained in which the position of the interface between the droplet layer and the non-droplet layer is estimated on the basis of a liquid volume of the droplets to be generated.

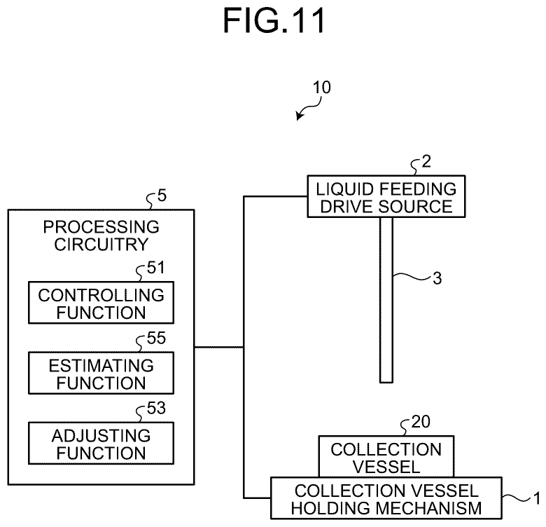

FIG. 11 is a block diagram illustrating an exemplary configuration of the liquid feeding apparatus 10 according to the fifth embodiment. In the present example, the liquid feeding apparatus 10 according to the fifth embodiment is different from the liquid feeding apparatus 10 according to the first embodiment for not including the interface detecting mechanism 4 and in that the processing circuitry 5 is configured not to execute the detecting function 52 but is configured to execute an estimating function 55. In the following sections, the differences will primarily be explained.

The estimating function 55 is configured to estimate the position of the interface between the droplet layer and the non-droplet layer in the collection vessel 20, on the basis of a generation condition of the droplets included in the droplet layer. More specifically, the estimating function 55 is configured to obtain a supply amount of the sample liquid and a supply amount of the oil in the generation of the droplets using the micro flow path and to further estimate the position of the interface between the droplet layer and the oil layer in the collection vessel 20, on the basis of the obtained supply amounts.

In this situation, the storage circuitry (not illustrated) has stored therein, in advance, information about the container (e.g., a micro tube or the like) used as the collection vessel 20. For example, the storage circuitry (not illustrated) has stored therein, in advance, information keeping volumes in correspondence with heights within the container, with respect to each type of container. In other words, the information is stored in advance in which the volumes of liquid held in the container are kept in correspondence with the heights within the container (the distances from the bottom of the container to the surface of the liquid) corresponding to the volumes.

For example, the estimating function 55 is configured to obtain the type of the container used as the collection vessel 20 and the supply amount of the oil for generating the droplets and to further estimate the position of the interface between the droplet layer and the oil layer in the collection vessel 20 (the distance from the bottom of the container to the interface between the droplets and the oil), on the basis of the type of the container and the supply amount that were obtained and the abovementioned information (the information keeping, with respect to each type of container, the volumes in correspondence with the heights within the container). In this situation, the type of the container used as the collection vessel 20 and the supply amount of the oil used for generating the droplets may be obtained from an apparatus configured to generate the droplets or may be obtained on the basis of an input operation performed by a user.

On the basis of the position of the interface between the droplet layer and the non-droplet layer estimated by the estimating function 55, the adjusting function 53 according to the fifth embodiment is configured to adjust the position of the interface between the droplet layer and the non-droplet layer, with respect to the position of the suction port of the liquid feeding tube. For example, the adjusting function 53 is configured to set the distance from the bottom of the container to the interface between the droplets and the oil as a moving distance of the arm 12 and configured to further align the position of the interface between the droplet layer and the oil layer with respect to the suction port of the liquid feeding tube, by moving the arm 12 holding the collection vessel 20 by the distance being set.

Further, in the above description, the example was explained in which, as the initial arrangement state of the liquid feeding tube 3 with respect to the collection vessel 20, the state in which the suction port 31 is in contact with the bottom of the collection vessel 20 is set; however, possible embodiments are not limited to this example. It is also acceptable to set an initial arrangement state of the liquid feeding tube 3 so that the suction port 31 of the liquid feeding tube 3 is at a predetermined height within the collection vessel 20.

In that situation, the estimating function 55 is configured to calculate the distance between the interface and the suction port 31, on the basis of the position of the interface between the droplet layer and the oil layer in the collection vessel 20 (the distance from the bottom of the container to the interface between the droplets and the oil) and the position of the suction port 31 (the distance from the bottom of the container to the suction port 31). The adjusting function 53 is configured to set the calculated distance as a moving distance of the arm 12 and to further align the position of the interface between the droplet layer and the oil layer with respect to the suction port of the liquid feeding tube, by moving the arm 12 holding the collection vessel 20 by the distance being set.

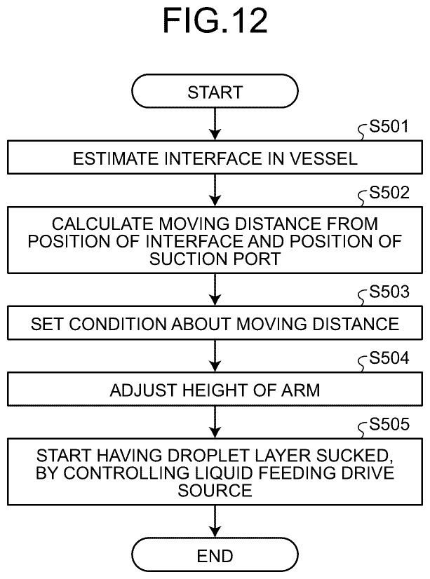

Next, a procedure in a process performed by the liquid feeding apparatus 10 according to the fifth embodiment will be explained, with reference to FIG. 12. FIG. 12 is a flowchart illustrating the procedure in the process performed by the liquid feeding apparatus 10 according to the fifth embodiment.

For example, as illustrated in FIG. 12, in the present embodiment, the estimating function 55 estimates the interface in the collection vessel 20 on the basis of the generation condition of the droplets (step S501) and calculates a moving distance of the arm 12 from the position of the interface and the position of the suction port 31 (step S502). The abovementioned process is realized, for example, as a result of the processing circuitry 5 invoking and executing a program corresponding to the estimating function 55 from the storage circuitry (not illustrated).

Subsequently, on the basis of the calculated moving distance, the adjusting function 53 sets a condition about a moving distance of the arm 12 (step S503) and adjusts the height of the arm 12 (step S504). The abovementioned process is realized, for example, as a result of the processing circuitry 5 invoking and executing the program corresponding to the adjusting function 53 from the storage circuitry (not illustrated).

After that, the controlling function 51 starts having the droplet layer sucked, by controlling the liquid feeding drive source 2 (step S505). The abovementioned process is realized, for example, as a result of the processing circuitry 5 invoking and executing the program corresponding to the controlling function 51 from the storage circuitry (not illustrated).

As explained above, according to the fifth embodiment, on the basis of the generation condition of the droplets included in the droplet layer, the estimating function 55 is configured to estimate the position of the interface between the droplet layer and the non-droplet layer in the collection vessel 20. On the basis of the position of the interface between the droplet layer and the non-droplet layer estimated by the estimating function 55, the adjusting function 53 is configured to adjust the position of the interface between the droplet layer and the non-droplet layer, with respect to the position of the suction port of the liquid feeding tube. Consequently, the liquid feeding apparatus 10 according to the fifth embodiment makes it possible to easily and conveniently feed the droplets in a selective manner.

### Sixth Embodiment

As a sixth embodiment, an example of a droplet generating apparatus including the liquid feeding apparatus 10 described above will be explained. More specifically, the droplet generating apparatus according to the sixth embodiment includes a micro flow path configured to generate liquid including a droplet layer and a non-droplet layer; and the liquid feeding apparatus 10 described above.

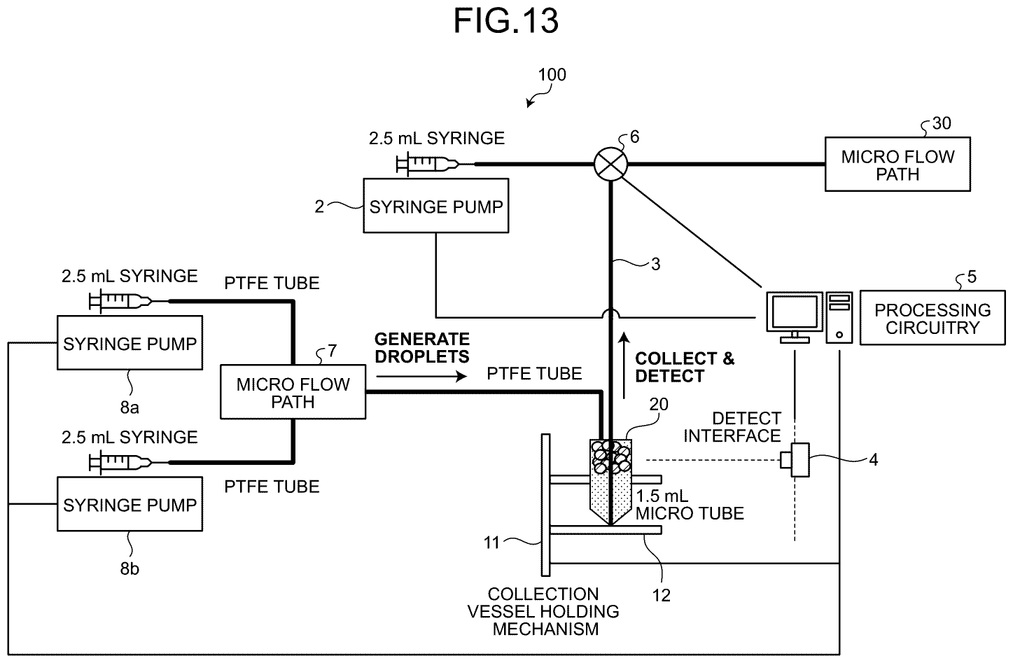

FIG. 13 is a block diagram illustrating an exemplary configuration of a droplet generating apparatus 100 according to the sixth embodiment. As illustrated in FIG. 13, the droplet generating apparatus 100 includes: the collection vessel holding mechanism 1 including the supporting unit 11 and the arm 12; a syringe pump serving as the liquid feeding drive source 2; the liquid feeding tube 3; the interface detecting mechanism 4; the processing circuitry 5; the switching valve 6, a micro flow path 7; a syringe pump 8a; and a syringe pump 8b and is configured to feed the droplets collected in the collection vessel 20 to the micro flow path 30 used for detection/analysis purposes. Further, although FIG. 13 illustrates the liquid feeding apparatus 10 including the interface detecting mechanism 4, the droplet generating apparatus 100 does not necessarily need to include the interface detecting mechanism 4. In other words, the droplet generating apparatus 100 may be configured to estimate the position of the interface on the basis of a generation condition of the droplets.

The collection vessel holding mechanism 1, the liquid feeding drive source 2, the liquid feeding tube 3, and the interface detecting mechanism 4 are configured in the same manner as those in the first to the fifth embodiments. In addition to the same configuration as the configuration in the first to the fifth embodiments, the processing circuitry 5 according to the sixth embodiment is configured to perform a process for generating the droplets. More specifically, the processing circuitry 5 is configured to control the generation of the droplets in the micro flow path 7, by controlling the syringe pump 8a and the syringe pump 8b.

The micro flow path 7 includes flow paths for generating the droplets. For example, the micro flow path 7 includes: a first injection port for injecting the liquid supplied from the syringe pump 8a; a first flow path through which the liquid injected through the first injection port flows; a second injection port for injecting the liquid supplied from the syringe pump 8b; a second flow path through which the liquid injected through the second injection port flows; a third flow path through which the droplets generated in a region where the first flow path intersects the second flow path flows; and an exit port for pumping out, to the outside, the liquid which includes the droplets and has flowed through the third flow path.

The syringe pump 8a is a supply unit configured to supply oil to the first flow path of the micro flow path 7. For example, the syringe pump 8a includes a Luer lock, while one end part of a PTFE tube is connected thereto. The other end part of the PTFE tube connected to the syringe pump 8a is connected to the first injection port of the micro flow path 7.

The syringe pump 8b is a supply unit configured to supply sample liquid to the second flow path of the micro flow path 7. For example, the syringe pump 8b includes a Luer lock, while one end part of a PTFE tube is connected thereto. The other end part of the PTFE tube connected to the syringe pump 8b is connected to the second injection port of the micro flow path 7.

To the exit port of the micro flow path 7, the one end part of the PTFE tube is connected, so that the droplets and the oil pumped out through the exit port are collected into a 1.5 mL micro tube, for example, used as the collection vessel 20.

In the droplet generating apparatus 100 according to the sixth embodiment, for example, each of the syringe pumps is configured by using a 2.5 ml syringe. By executing the controlling function 51, the processing circuitry 5 is configured to generate the droplets by controlling the syringe pump 8a and the syringe pump 8b. More specifically, by injecting the oil and the sample liquid into the micro flow path 7 on the basis of a generation condition of the droplets set in advance, the controlling function 51 is configured to cause the liquid including the droplets and the oil to be collected into the collection vessel 20.

After that, as a result of the processing functions performing the processes described in any of the above embodiments, the droplet generating apparatus 100 is configured to collect the droplets and feed the droplets to the micro flow path 30 by controlling the interface detecting mechanism 4, the collection vessel holding mechanism 1, the syringe pump 2, and the switching valve 6.

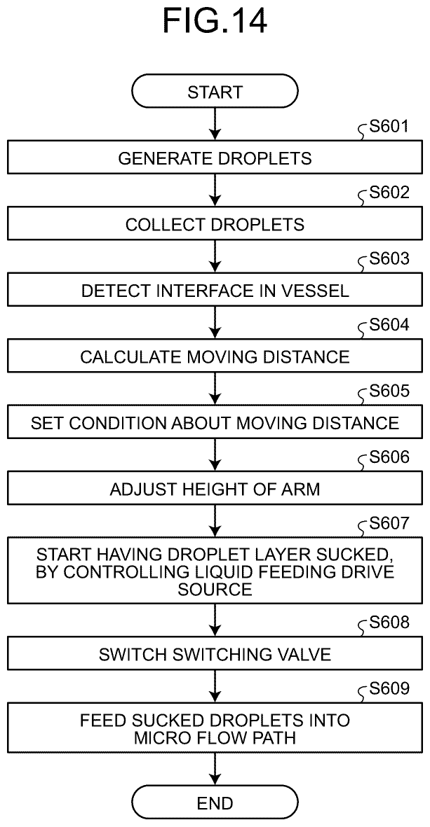

Next, a procedure in a process performed by the droplet generating apparatus 100 according to the sixth embodiment will be explained, with reference to FIG. 14. FIG. 14 is a flowchart illustrating the procedure in the process performed by the droplet generating apparatus 100 according to the sixth embodiment. In the present example, steps S603 through S607 in FIG. 14 are the same as the processes at steps S101 through S105 in FIG. 5.

For example, in the droplet generating apparatus 100 according to the sixth embodiment, as illustrated in FIG. 14, the controlling function 51 generates the droplets by controlling the syringe pump 8a and the syringe pump 8b (step S601) and causes the generated droplets to be collected into the collection vessel 20 (step S602). The abovementioned process is realized, for example, as a result of the processing circuitry 5 invoking and executing the program corresponding to the controlling function 51 from the storage circuitry (not illustrated).

Subsequently, the detecting function 52 detects the interface in the collection vessel 20 (step S603) and calculates a moving distance of the camera 42 (step S604). After that, on the basis of the calculated moving distance of the camera 42, the adjusting function 53 sets a condition about a moving distance of the arm 12 (step S605) and adjusts the height of the arm 12 (step S606).

Subsequently, the controlling function 51 starts having the droplet layer sucked by controlling the liquid feeding drive source 2 (step S607), and after the droplets are sucked, switches the switching valve (step S608). After that, by controlling the syringe pump 2, the controlling function 51 feeds the sucked droplets to the micro flow path 30 (step S609).

As explained above, according to the sixth embodiment, the micro flow path 7 is configured to generate the liquid including the droplet layer and the non-droplet layer. The collection vessel holding mechanism 1 is configured to hold the collection vessel 20 used for collecting the liquid including the droplet layer and the non-droplet layer. The liquid feeding tube 3 is configured to feed the liquid from the inside of the collection vessel 20. The adjusting function 53 is configured to adjust the position of the interface between the droplet layer and the non-droplet layer, with respect to the position of the suction port 31 of the liquid feeding tube 3. Consequently, the droplet generating apparatus 100 according to the sixth embodiment makes it possible to feed the generated droplets properly.

### OTHER EMBODIMENTS

In the sixth embodiment described above, the example was explained in which the droplet generating apparatus 100 is configured to adjust the position of the interface, by changing the height of the arm 12 of the collection vessel holding mechanism 1 holding the collection vessel 20; however, possible embodiments are not limited to this example. For instance, the droplet generating apparatus 100 is also capable of adjusting the position of the interface, by feeding the liquid in the non-droplet layer to the inside of the collection vessel 20.

In that situation, the adjusting function 53 is configured to adjust the position of the interface with respect to the position of the suction port 31 of the liquid feeding tube 3, by feeding the liquid in the non-droplet layer to the collection vessel 20 on the basis of the position of the interface between the droplet layer and the non-droplet layer. For example, when the suction port of the liquid feeding tube 3 is positioned at the droplet layer, the adjusting function 53 may be configured to exercise control so that the position of the interface in the collection vessel 20 is aligned with the position of the suction port 31 of the liquid feeding tube 3, by controlling the syringe pump 8a so that the oil is supplied.

In an example, on the basis of the information keeping the volumes of liquid held in the container in correspondence with the heights within the container (the distances from the bottom of the container to the surface of the liquid) corresponding to the volumes, as well as the height of the suction port 31 in the collection vessel 20, and the position of the interface in the collection vessel 20, the adjusting function 53 may be configured to calculate the amount of oil to be supplied and to control the syringe pump 8a. With this configuration, the droplet generating apparatus 100 is able to selectively feed the droplets without controlling the collection vessel holding mechanism 1.

Further, the term “processor” used in the above explanations denotes, for example, a Central Processing Unit (CPU), a Graphics Processing Unit (GPU), or circuitry such as an Application Specific Integrated Circuit (ASIC) or a programmable logic device (e.g., a Simple Programmable Logic Device (SPLD), a Complex Programmable Logic Device (CPLD), or a Field Programmable Gate Array (FPGA)). The one or more processors realize the functions by reading and executing the programs saved in a memory. Alternatively, instead of having the programs saved in the memory, it is also acceptable to directly incorporate the programs into the circuitry of the one or more processors. In that situation, the one or more processors realize the functions by reading and executing the programs incorporated in the circuitry thereof. Further, the processors of the present embodiments do not each necessarily need to be structured as a single piece of circuitry. It is also acceptable to structure one processor by combining together a plurality of pieces of independent circuitry so as to realize the functions thereof.

Further, the constituent elements of the apparatuses presented in the drawings for explaining the above embodiments are based on functional concepts. Thus, it is not necessarily required to physically configure the constituent elements as indicated in the drawings. In other words, specific modes of distribution and integration of the apparatuses are not limited to those illustrated in the drawings. It is acceptable to functionally or physically distribute or integrate all or a part of the apparatuses in any arbitrary units, depending on various loads and the status of use. Further, all or an arbitrary part of the processing functions performed by the apparatuses may be realized by a CPU and a program analyzed and executed by the CPU or may be realized as hardware using wired logic.

Further, it is possible to realize any of the methods explained in the above embodiments, by causing a computer such as a personal computer or a workstation to execute a program prepared in advance. The program may be distributed via a network such as the Internet. Further, the program may be recorded on a non-transitory computer-readable recording medium such as a hard disk, a flexible disk (FD), a Compact Disk Read-Only Memory (CD-ROM), a Magneto Optical (MO) disk, a Digital Versatile Disk (DVD), or a flash memory such as a Universal Serial Bus (USB) memory or a Secure Digital (SD) card memory, so as to be executed as being read by a computer from the non-transitory recording medium.

As explained above, according to at least one aspect of the embodiments, it is possible to properly feed the droplets.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A liquid feeding apparatus comprising:
a collection vessel holder configured to hold a collection vessel used for collecting liquid including a droplet layer and a non-droplet layer;
a liquid feeding tube configured to feed the liquid from an inside of the collection vessel; and
processing circuitry configured to adjust a position of an interface between the droplet layer and the non-droplet layer with respect to a position of a suction port of the liquid feeding tube.

2. The liquid feeding apparatus according to claim 1, wherein
the processing circuitry is configured to detect the position of the interface between the droplet layer and the non-droplet layer in the collection vessel, and
the processing circuitry is configured to adjust the position of the interface between the droplet layer and the non-droplet layer with respect to the position of the suction port of the liquid feeding tube, on a basis of the detected position of the interface between the droplet layer and the non-droplet layer.

3. The liquid feeding apparatus according to claim 1, wherein
the processing circuitry is configured to estimate the position of the interface between the droplet layer and the non-droplet layer in the collection vessel, on a basis of a generation condition of droplets included in the droplet layer, and
the processing circuitry is configured to adjust the position of the interface between the droplet layer and the non-droplet layer with respect to the position of the suction port of the liquid feeding tube, on a basis of the estimated position of the interface between the droplet layer and the non-droplet layer.

4. The liquid feeding apparatus according to claim 1, wherein the processing circuitry is configured to align the position of the suction port of the liquid feeding tube with the position of the interface, by adjusting a position in which the collection vessel is held by the collection vessel holder, on a basis of the position of the interface between the droplet layer and the non-droplet layer.

5. The liquid feeding apparatus according to claim 1, wherein the processing circuitry is configured to adjust the position of the interface with respect to the position of the suction port of the liquid feeding tube, by feeding liquid in the non-droplet layer to the collection vessel on a basis of the position of the interface between the droplet layer and the non-droplet layer.

6. The liquid feeding apparatus according to claim 4, wherein the processing circuitry is configured to align the position of the interface with the position of the suction port of the liquid feeding tube, by moving the collection vessel holder by a distance between the position of the interface and the position of the suction port of the liquid feeding tube.

7. The liquid feeding apparatus according to claim 2, wherein
the processing circuitry is configured to further detect the position of the suction port of the liquid feeding tube in the collection vessel, and
the processing circuitry is configured to adjust the position of the interface between the droplet layer and the non-droplet layer with respect to the position of the suction port of the liquid feeding tube, on a basis of the position of the interface between the droplet layer and the non-droplet layer and the position of the suction port of the liquid feeding tube that were detected.

8. The liquid feeding apparatus according to claim 1, wherein
after the position of the interface is adjusted with respect to the position of the suction port of the liquid feeding tube, the processing circuitry is configured to judge a positional relationship between the position of the suction port and the position of the interface, and
the processing circuitry is configured to re-adjust the position of the interface with respect to the position of the suction port, on a basis of a result of the judgment on the positional relationship.

9. A droplet generating apparatus comprising:
a micro flow path configured to generate liquid including a droplet layer and a non-droplet layer;
a collection vessel holder configured to hold a collection vessel used for collecting the liquid including the droplet layer and the non-droplet layer;
a liquid feeding tube configured to feed the liquid from an inside of the collection vessel; and
processing circuitry configured to adjust a position of an interface between the droplet layer and the non-droplet layer with respect to a position of a suction port of the liquid feeding tube.
